(19) United States
(12) Patent Application Publication
(10) Pub. No.: US 2025/0079616 A1
(43) Pub. Date: Mar. 6, 2025

(54) OUTER MODULE COVER WITH INTEGRATED GAS DISCHARGE FOR BATTERY MODULE

(71) Applicant: Oerlikon Friction Systems (Germany) GmbH, Bremen (DE)

(72) Inventor: Heribert Walter, Gottingen (DE)

(73) Assignee: Oerlikon Friction Systems (Germany) GmbH, Bremen (DE)

(21) Appl. No.: 18/725,677

(22) PCT Filed: Jan. 18, 2023
(86) PCT No.: PCT/EP2023/051116

§ 371 Date: Jun. 28, 2024

(30) Foreign Application Priority Data
Jan. 21, 2022 (DE) 10 2022 101 425.8

(51) Int. Cl. H01M 50/276; H01M 50/342; H01M 50/358

(52) U.S. Cl. CPC H01M 50/276; H01M 50/3425; H01M 50/358

(57) ABSTRACT

The present invention relates to an outer module cover (1) with integrated gas discharge for a battery module (3) made up of battery cells (4), wherein the outer module cover (1) has a cover plate (8) in which rupture cut-outs (2) are provided that are through-openings in the cover plate (8), and the rupture cut-outs (2) are closed with a rupture disc (10) which is designed to open when acted upon by gas (7) escaping from a battery cell (4) in the event of a thermal failure in order to discharge the escaping gas (7) away from the battery module (3), wherein the outer module cover (1) is made of a high-temperature-resistant fiber-reinforced material.

The present invention relates to an outer module cover for a battery module which ensures a safe discharge of a flow of hot gas enriched with conductive particles that, in the event of a thermal failure of a battery cell, escapes from the cell, so as to thereby prevent a short circuit with arcing between the battery housing ground and current-conducting components.

Rechargeable battery systems, in particular lithium ion battery cells: are used nowadays for vehicles that have an electric drive. A multiplicity of battery cells are combined here to form a battery module and a plurality of battery modules are combined and electrically interconnected with one another to form a battery pack.

For the operation of vehicles, these battery systems must have very high energy densities, which, however, on the other hand, also entail a high safety risk.

DE 2018 125 618 A1 discloses a protective unit for the safe electrical interconnection of battery cells for the creation of battery modules and battery stacks for a high-voltage battery for motor vehicles, wherein, on the cell terminal side of the battery cells is placed a cell contact system, the system being formed from an electrically insulating frame and electrically conducting cell connectors introduced in the frame for the desired interconnection. Between the cell contact system and the cell terminal side of the battery cells, there is an electrically insulating intervening layer having cut-outs for passing through the cell terminals and a row of openings for discharge of hot gas that, in the event of a thermal failure of a battery cell arranged beneath it, escapes out of the safety valve of the battery cell. The hot gas escaping from the damaged battery cell is discharged via the openings in the intervening layer and corresponding cut-outs in the cell contact system into a receiving space of the battery housing, in which the battery module or battery modules is or are arranged.

A strip-shaped, electrically insulating, protective mat can extend along and above the openings in the intervening layer and protect the current-conducting components of the high-voltage battery from the hot gas and prevent fire or flames from escaping out from the battery housing.

DE 10 2013 220 778 A1 describes a battery housing for a vehicle battery, such as, for example, a lithium ion traction battery, which, for reducing the weight of known such housings made from metal, is formed from a polymer composite material. Moreover, a battery housing made of a polymer composite material has the advantage of being electrically insulating. The battery housing comprises a battery receiving space as well as a cover for placement on the battery receiving space. The cover can have at least one opening for filling the battery, two electrode through-openings for passing though battery electrodes, and/or one predetermined breaking spot for degassing the battery.

A safer operation of this battery systems is possible only up to a relatively low critical temperature value. Already at approximately 80° C., oxidation processes between constituents of the electrolytes and components of the electrodes of the battery cells start to occur and lead to a progressive heating of the cell and, finally, to damage to the cell and even to so-called thermal runaway. Such a runaway usually results in an opening of the cell that can lead to a bursting or an explosion. In this process, a readily combustible gas escapes from the cell under high pressure and usually ignites immediately on contact with air and has very high temperatures. The very hot gas entrains with it, in addition, conductive particles, such as graphitic carbon, metallic particles, and other decomposition products of the cell contents.

Of key importance for the operational safety of battery cells and, in particular, also of possible vehicle occupants is the avoidance of an energy transfer to adjacent cells and modules in order to suppress a spread of the thermal runaway or at least to prevent it as long as possible. In particular, it must be prevented that gas loaded with conductive particles leads to a short circuit between the current-conducting components and the ground of the battery pack and forms an arc, which can generate temperatures of up to several thousand degrees Celsius. Such high temperatures can no longer be kept under control using the insulation materials presently available and, in a very short period of time, inevitably lead to a thermal runaway of the entire battery system.

For the operational safety and for the protection of vehicle occupants, it is necessary to ensure an appropriate protection concept for a battery pack, so that, following the detection of the first sign of a thermal runaway of a battery cell, no sparks or flames escape from the battery pack over a period of several minutes, that is, are visible. Preferably, this period of time up to when the flames are visible outside of the battery pack should not be shorter than 5 minutes in order to meet the safety standard.

The present invention starts here. The present invention relates to an outer module cover with integrated gas discharge structure having the features of claim 1.

The dependent claims relate to preferred embodiments.

The outer module cover with integrated gas discharge according to the invention enables a hot gas flow that is loaded with conductive particles and escapes from an overheated module to be discharged from the battery pack rapidly and directly, without any occurrence of a short circuit and an arcing between current-conducting components and the ground of the battery pack.

The occurrence of visible flames outside of the battery pack can thereby be prevented for a period of at least 5 minutes and, in particular, at least 7 minutes and longer, as required for meeting safety regulations.

In addition, the outer module cover according to the invention has a very good three-dimensional formability during production and thus has the advantage that it is possible to obtain a desired shape precisely and without great effort.

The outer cover according to the invention enables hot gas loaded with conductive particles to be discharged from its site of formation via the module out of the battery pack without the conductive gas coming into contact with current-conducting components and thereby producing a short circuit between the current-conducting components, such as busbars, cell connectors, module connectors, etc., and the ground of the battery pack. Thereby prevented is the formation of an arc, which is created by a short circuit between the ground of the housing and the current-conducting components by way of the electrically conductive gas phase that is formed during a thermal runaway.

In particular, the outer cover according to the invention is conceived for the use of battery systems made up of prismatic battery cells, which nowadays are commonly employed in electric vehicles. However, it is obvious that the outer module cover can be altered for other types of batteries, such as pouch cells or cylindrical cells, in a straightforward manner.

Prismatic cells, battery modules, and battery packs consisting of these as well as the production thereof are generally known.

Prismatic cells have a metallic housing, usually made of aluminum or else stainless steel and having two electrical contacts on a side face, with a safety valve being provided between the electrical contacts. The safety valve opens once the internal pressure of the cell exceeds a defined critical value in order to make possible a directed escape of gas. A number of prismatic battery cells, which varies as needed, are combined in succession, main face to main face, to form a battery module.

The module cover according to the invention is placed on the module on the side with the safety valve. The outer module cover has a flat cover plate, the width and length of which correspond to the dimensions of the module. As needed, the cover plate can be adapted to the three-dimensional geometry of the supporting face of the module so as, for example, to compensate for unevenness of the supporting face of the module.

Provided in the cover plate of the outer module cover are rupture cut-outs, which are through-openings in the outer module cover.

Via these rupture cut-outs, gas that escapes in the event of an overheating of the cell and the opening of the safety valve can be discharged from the face of the module using the safety valve or safety valves.

The number and position of the rupture cut-outs of an outer module cover are governed by the number of battery cells of a battery module. In addition, a rapid discharge with a short discharge path of the gas escaping from the safety valve of the battery cell should be possible. Appropriately, therefore, each safety valve should be associated with a rupture cut-out of the outer module cover, which, when the outer cover is placed on the module, comes to lie above the safety valve or safety valves. The circumferential shape and size of the rupture cut-out should correspond to the dimensions of the safety valves or preferably be larger.

The rupture cut-outs, like the safety valves of the battery cells, are closed with a rupture disc, which opens only when acted upon by the temperature and pressure of the hot gas.

In this way, it can be ensured that the gas discharge occurs directly via the propagating cell. The rupture cut-outs above the non-propagating cells remain closed in order to prevent any contamination of these regions with the electrically conductive particles from the hot gas and to suppress a bypass of the hot gas escaping away from the module through additionally open rupture cut-outs back into the module.

The rupture cut-out should be situated as tightly as possible above the safety valve in order to keep the path of escape of the gas from the battery cell to the rupture cut-out as short as possible. For this purpose, in the region of the cover plate of the module cover, it is possible to provide an indentation or depression, so that this depressed region comes to lie tightly above the safety valve.

The outer module cover is made of a high-temperature-resistant material in order for a safe discharge of the hot gas to take place, without the outer module cover itself catching fire or being deformed on account of thermal action. Appropriately, the outer module cover has a temperature resistance of up to at least 1400° C.

In addition, the material for the outer module cover should itself be electrically nonconductive.

In accordance with the invention, the outer module cover can be a layer structure consisting of layers of fiber-reinforced material. For the layers consisting of fiber-reinforced material, high-temperature-resistant fibers are used. In particular, it is possible to use mineral fibers, such as, for example, basalt fibers, glass fibers, silicate fibers, or oxide ceramic fibers.

The fibers can be present in the form of a fabric structure, such as a woven or nonwoven fabric, it being possible to produce the fabric structure itself from rovings or yarn made from these fibers.

The grain of the fiber is preferably bidirectional, in particular, for example, 0°/90°, although the grain of the fiber can vary as needed and, for example, can also be multidirectional, such as, for example, 0°/90″/45″, etc.

The plastics used as matrix material likewise exhibit a high temperature resistance. Examples of them are silicone resins, in particular silicone resins with a high SiO proportion, in particular a SiO proportion of 50 to 90% and, especially particularly, of 75% and greater.

Silicone resins with a SiO proportion of at least 80% have proven to be particularly suitable.

As silicone resin, it is possible to use di- and/or trifunctional polysiloxanes, preferably with methyl and/or phenyl substituents.

An example of a suitable silicone resin is SILRES® MK, a tradename marketed by the Wacker company.

The total thickness of the outer module cover should be as small as possible in view of the desired saving of space; preferably, the total thickness should not exceed 1.5 mm. Preferred is a thickness of 1 mm or less in order to take into account the desired compact space-saving construction of battery arrangements.

The individual layers of the outer module cover can have different fibers and/or different fiber orientations.

For example, a layer structure can consist of one or two cover layers made of a first fiber-reinforced material with—as needed—one intervening layer or a plurality of intervening layers made of a second fiber-reinforced material. The layers made of different fiber-reinforced materials can be arranged in alternation.

The thickness of the individual layers should be as thick as necessary, but as thin as possible.

As material for the rupture disc, it is likewise possible to use a fiber-reinforced material.

Examples of suitable fibers are glass silk or fibers made of a plastic fabric, such as, for example, those made of aramid, polyphenylene ether (PPE), or polypropylene (PP), and, as matrix, an epoxide resin, such as, for example, one based on bisphenol A.

In the event of a thermal runaway, the outer cover according to the invention with integrated gas discharge can delay the occurrence of flames and sparks outside of a battery module for a period of at least 5 minutes and in particular at least 7.5 minutes and longer.

Beyond this, the outer cover according to the invention has an outstanding three-dimensional formability during production, so that it is possible to obtain a desired shape precisely without great effort. It can be contoured three-dimensionally so as, in this way, to adapt the cover plate and/or edges to the surface structures of the support faces on the battery.

The present invention will be explained in detail below on the basis of figures, which show an embodiment and application of the outer cover according to the invention with integrated gas discharge.

Shown are:

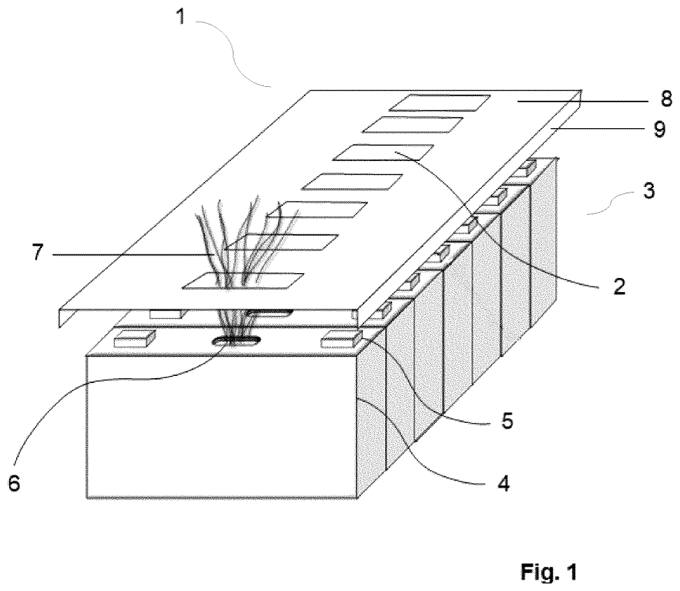

FIG. 1 an embodiment for an outer cover according to the invention with integrated gas discharge, in which the outer module cover is arranged over a battery module consisting of prismatic battery cells;

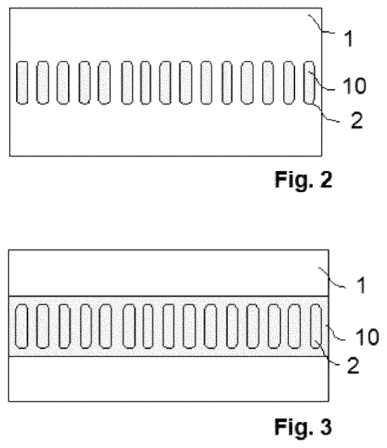

FIG. 2 a plan view of an outer cover according to the invention; and

FIG. 3 a view from below of the outer module cover in accordance with FIG. 2.

Shown in FIG. 1 is the outer cover 1 according to the invention with rupture cut-outs 2 on a battery module 3 consisting of a multiplicity of prismatic battery cells 4 in an exploded illustration.

The outer module cover 1 lies on the side of the module 3 with the electrical contacts 5. Each battery cell 4 has a safety valve 6 between the electrical contacts 5.

Provided in the outer module cover 1 are a corresponding number of rupture cut-outs 2, with the position of the rupture cut-outs 2 in the outer module cover 1 being chosen in such a way that, in the state in which the cover is placed on the battery module 3, a rupture cut-out 2 comes to lie above a safety valve 6. That is, in the embodiment, shown here, each safety valve 6 is associated with a rupture cut-out 2.

The shape and size of the outer module cover 1 are governed by the dimensions and shape of the module 3. In this case, the latter has a flat rectangular cover plate 8 with rectangular rupture cut-outs 2 that are arranged in succession along the longitudinal axis of the cover plate 8 and in correspondence to the position of the safety valves 6.

Provided along each of the lengthwise sides of the cover plate 8 is a downward-directed edge 9 in order to be able to hold the outer module cover 1 securely on the module 3.

In the assembled state, the cover plate 8 lies on the contacts 5 as the highest elevation on this side of the battery module 3 and the edges 9 lie on the side faces.

In accordance with an embodiment, the region of the cover plate 8 with the rupture cut-outs 2 can be depressed in order to keep the distance between the rupture cut-out 2 and the safety valve 6 as small as possible and to keep the path of escape of the gas as short as possible.

For this purpose, for example, the middle region of the cover plate 8 with the rupture cut-outs 2 can be depressed in comparison to the adjacent regions of the cover plate 8 and form a channel that extends along the longitudinal axis.

Shown in FIG. 1 is the situation of a thermal runaway of the frontmost battery cell 4 of the module 3, with the hot gas flow 7 that exits the safety valve 6 being carried off directly and unimpeded through the above-lying rupture cut-out 2 away from the region of the battery module 3.

For this purpose, the rupture cut-outs 2 are designed to be sufficiently large so that the hot gas flow 7 flowing out of the underlying safety valve 6 can be discharged rapidly and unimpeded from the module 3. In the embodiment shown in FIG. 1, the rupture cut-outs 2 are about twice as large as the safety value 6 in terms of length and width.

Of key importance is that the exiting hot gas flow 7 containing electrically conductive particles is discharged rapidly from the module 3 in order to prevent any contact with adjacent electrically conducting components and accordingly to prevent a possible short circuit, which can lead to a spread of the thermal runaway to adjacent cells.

Shown in FIGS. 2 and 3 is an outer cover 1 according to the invention as seen from above and from below. As in FIG. 1, a row of equivalently shaped rupture cut-outs 2 in succession is provided on the cover plate of the outer module cover centrally along the longitudinal axis in correspondence to the position of the safety valves 6 of a module 3.

The rupture cut-outs 2 are closed on the bottom side of the cover plate 8 with a rupture disc 10, with the rupture disk 10 in the embodiment shown here extending and fully covering all the rupture cut-outs 2 in a flat manner.

The rupture disc 10 in this case consists of a fiberglass-reinforced material in an epoxide resin matrix.

The rupture disc 10 is to be chosen to be sufficiently thin that it opens safely when exposed to gas, but, on the other hand, is not combustible.

Shown in FIG. 1, for highlighting of the present outer cover 1 according to the invention with integrated gas discharge, is the use of the outer module cover 1 for the battery module 3 consisting of prismatic battery cells 4, for which the safety valve 6 is provided between the electrical contacts 5.

However, it is obvious that the outer cover according to the invention 1 can also be employed in a straightforward manner for battery cell constructions that deviate from the above, in which, for example, the safety valve 6 assumes a different position than that between the contacts 5, such as, for example, a position on the other face of the battery housing.

On account of the good three-dimensional formability, it is also possible to adapt the outer cover 1 according to the invention in a straightforward manner to irregularities due to construction, such as, for example, differences in height or the like on the support faces of the battery cells or modules.

For example, the outer module cover can be chosen in such a way that it also covers or extends over module connectors, by means of which adjacent modules are combined to form a module pack.

### EXAMPLE

A flame exposure test was carried out with an outer module according to the invention.

The outer module cover consisted of a 4-layer fiber-reinforced material with an upper cover layer and a lower cover layer made of a composite consisting of basalt fabric with an area weight of 420 g/m² and two intervening layers made of silica fabric with an area weight of 300 g/m². The matrix material was a silicone resin, SILRES® MK, of the Wacker company.

The total thickness of the outer module cover was 1.3 mm. The thickness of each of the basalt fiber-reinforced layers was 0.35 mm and the thickness of each of the silicate fiber-reinforced layers was 0.3 mm.

The dimensions of the rupture cut-outs were 70 mm×18 mm with a web spacing 16 mm.

As rupture disc, a fiber-glass composite that had a thickness of 0.1 mm and consisted of glass silk with an area weight of 164 g/m² and a matrix made of an epoxide resin that is marketed under the tradename EPIKOTE™ Resin 828 of the Hexion company and is produced from bisphenol-A and epichlorohydrin was employed.

The rupture disc was attached adhesively using a DOW Corning RTV 3145 adhesive.

The result of the flame exposure test was that the rupture disc with a thickness of 0.1 mm opened sufficiently fast when exposed to flame, without the rupture discs of adjacent rupture cut-outs thereby being damaged.

### LIST OF REFERENCE NUMBERS

1 outer module cover
2 rupture cut-out
3 battery module
4 battery cell
5 electrical contact
6 safety valve
7 gas flow
8 cover plate
9 edge
10 rupture disc

1. An outer module cover (1) with integrated gas discharge for a battery module (3) made up of battery cells (4),
wherein the outer module cover (1) has a cover plate (8), in which there are rupture cut-outs (2), which are through-openings in the cover plate (8), and the rupture cut-outs (2) are closed with a rupture disc (10), which is designed to open when acted upon by gas (7) that escapes out of the battery cell (4) in order to discharge the gas (7) from the battery module (3), wherein the outer module cover (1) is made from a high-temperature-resistant fiber-reinforced material.

2. The outer module cover (1) according to claim 1,
wherein the rupture cut-outs (2) in the cover plate (8) are arranged in such a way that, when placed on a battery module (3), they come to lie above a safety valve (6) of the battery cells (4).

3. The outer module cover (1) according to claim 1,
wherein the rupture disc (10) is placed on the bottom side of the cover plate (8), which is to face the battery module (3).

4. The outer module cover (1) according to claim 3,
wherein the rupture disc (10) extends in one piece over all rupture cut-outs (2) in the cover plate (8) and closes them.

5. The outer module cover (1) according to claim 1,
wherein the outer module cover (1) is designed as a covering for a battery module (3) composed of prismatic battery cells (4).

6. The outer module cover (1) according to claim 1,
wherein the fiber material for the fiber-reinforced material is a mineral fiber chosen from the group consisting of: basalt fibers, glass fibers, silicate fibers, and oxide ceramic fibers.

7. The outer module cover (1) according to claim 1,
wherein the outer module cover (1) is made from two or more layers of a fiber-reinforced material.

8. The outer module cover (1) according to claim 7,
wherein one layer or a plurality of layers of the layer structure is or are made from different fiber-reinforced materials.

9. The outer module cover (1) according to claim 1,
wherein the matrix of the fiber-reinforced material is a silicone resin with a SiO proportion of 50 to 90%.

10. The outer module cover (1) according to claim 1,
wherein the cover plate (8) and/or the edge (9) are three-dimensionally contoured.

11. Use of an outer module cover (1) according to claim 1 for a battery module (3) composed of prismatic battery cells (4) for electric vehicles.
